(19) United States
(12) Patent Application Publication
(10) Pub. No.: US 2008/0278600 A1
(43) Pub. Date: Nov. 13, 2008

(54) Camera Apparatus

(75) Inventors: Hideo Cho, Kanagawa (JP); Yuichi Asami, Kanagawa (JP); Tomio Shimizu, Kanagawa (JP); Satoshi Uchikura, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/569,768

(22) PCT Filed: Jun. 2, 2005
(86) PCT No.: PCT/JP2005/010150

§ 371 Date: Feb. 6, 2007

(30) Foreign Application Priority Data
Jun. 3, 2004 (JP) 2004-165990

(51) Int. Cl. H04N 9/73

(52) U.S. Cl. 348/223.1; 348/E09.051

(57) ABSTRACT

It is an object of the present invention to provide a camera apparatus that can take images over a long period of time while automatically controlling, in white balance, the images. The camera apparatus comprises image providing means 11 for providing R-, G-, and B-images corresponding to three primary colors in light, converting means 12 for converting the R-, G-, and B-images into R-, G-, and B-image signals, gain adjusting means 13 for adjusting gains corresponding to the R-, G-, and B-image signals, and regulating the R-, G-, and B-image signals on the basis of the adjusted gains, white balance controlling means 14 for controlling, in white balance, the regulated R-, G-, and B-image signals, and image signal outputting means 15 for outputting the R-, G-, and B-image signals controlled in white balance, wherein the white balance controlling means 14 includes image signal sampler for extracting, from the regulated R-, G-, and B-image signals, R-, G-, and B-image signals corresponding to a specific sampling area, the extracted R-, G-, and B-image signals having R-, G-, and B-peak values, peak value detector for detecting the R-, G-, and B-peak values from the extracted R-, G-, and B-image signals, R-level controller for controlling, in level, the regulated R-image signal on the basis of a difference between the G- and R-peak values, and B-level controller for controlling, in level, the regulated B-image signal on the basis of a difference between the G- and B-peak values.

### TECHNICAL FIELD OF THE INVENTION

This invention relates to a camera apparatus, and more particularly to a camera apparatus for taking images over a long period of time while automatically controlling, in white balance, the images.

### DESCRIPTION OF THE RELATED ART

As is well known to those skilled in the art, an image taken under illumination higher in color temperature than white illumination is tinged with blue. On the other hand, an image taken under illumination lower in color temperature than white illumination is tinged with red. Accordingly, it is essential and important for a camera apparatus to correct, in white balance, the image on the basis of color temperature of illumination.

Up until now, there have been proposed a wide variety of camera apparatuses of this type, one typical example of which is disclosed in Jpn. unexamined patent publication No. S62-128691 (p2, upper right column, lines 5 to 18, FIG. 1), and which is adapted to correct, in white balance, image signals on the basis of color temperature of illumination.

The conventional camera apparatus, however, encounters such a problem that the image signals tends to be deteriorated in white balance when the image signals are automatically and unconditionally corrected in white balance on the basis of peak values of images taken under non-white illumination.

### DISCLOSURE OF THE INVENTION

### Problems to be Solved by the Invention

It is, therefore, an object of the present invention to provide a camera apparatus that can take images over a long period of time while automatically controlling, in white balance, the images.

### Means for Solving the Problems

The camera apparatus according to the first invention, comprises: image providing means for providing R-, G-, and B-images corresponding to three primary colors in light; converting means for converting the R-, G-, and B-images into R-, G-, and B-image signals; gain adjusting means for adjusting gains corresponding to the R-, G-, and B-image signals, and regulating the R-, G-, and B-image signals on the basis of the adjusted gains; white balance controlling means for controlling, in white balance, the regulated R-, G-, and B-image signals; and image signal outputting means for outputting the R-, G-, and B-image signals controlled in white balance, wherein the white balance controlling means includes: image signal sampler for extracting, from the regulated R-, G-, and B-image signals, R-, G-, and B-image signals corresponding to a specific sampling area, the extracted R-, G-, and B-image signals having R-, G-, and B-peak values; peak value detector for detecting the R-, G-, and B-peak values from the extracted R-, G-, and B-image signals; R-level controller for controlling, in level, the regulated R-image signal on the basis of a difference between the G- and R-peak values; and B-level controller for controlling, in level, the regulated B-image signal on the basis of a difference between the G- and B-peak values.

The camera apparatus thus constructed according to the first invention can control the white balance by using R-, G-, and B-image signals corresponding to appropriate parts of the R-, G-, and B-images.

In the camera apparatus according to the second invention, the white balance controlling means is adapted to utilize, as the R-, G-, and B-peak values, mean values of the R-, G-, and B-peak values calculated over a first period of time.

The camera apparatus thus constructed according to the second invention can change a control speed of the white balance.

In the camera apparatus according to the third invention, the white balance controlling means is adapted to stop controlling the white balance when the judgment is made that an absolute value of either the difference between the G- and R-peak values or the difference between the G- and B-peak values exceeds a specific threshold level.

The camera apparatus thus constructed according to the third invention can keep the white balance within an appropriate range by automatically controlling the white balance.

In the camera apparatus according to the fourth invention, the white balance controlling means is adapted to stop correcting the white balance when the judgment is made that the while balance meets a specific requirement.

The camera apparatus thus constructed according to the fourth invention can forcibly stop controlling the white balance when the white balance meets a requirement.

In the camera apparatus according to the fifth invention, the white balance controlling means is adapted to stop correcting the white balance when the judgment is made that the gains adjusted by the gain adjusting means are respectively larger than or equal to threshold levels.

The camera apparatus thus constructed according to the fifth invention can keep the white balance within an appropriate range without deteriorating the white balance.

In the camera apparatus according to the sixth invention, the white balance controlling means is adapted to stop, over a second period of time, correcting the white balance after allowing the R-, and G-level controller to perform a level control of the R-image signal, or allowing the B-level controller to perform a level control of the B-image signal.

The camera apparatus thus constructed according to the sixth invention can control the white balance without falling into a negative spiral of hunting.

### Advantageous Effect of the Invention

The camera apparatus according to the present invention has an advantageous effect of automatically controlling the white balance, and keeping the white balance within an appropriate range by comprising while balance controlling means.

The present invention and many of the advantages thereof will be better understood from the following detailed description when considered in connection with accompanying drawings.

### BRIEF DESCRIPTION OF THE DRAWINGS

FIG. 1 is a general block diagram showing the camera apparatus according to the present invention.

FIG. 2 is a detailed block diagram showing the camera apparatus according to the present invention.

FIG. 3 is a flowchart for explaining the first main routine to be executed by the camera apparatus according to the first embodiment of the present invention.

FIG. 4 is a waveform chart schematically showing the R-, G-, and B-image signals produced by the camera apparatus according to the first embodiment of the present invention.

FIG. 5 is a flowchart for explaining the R-level control routine to be executed by the camera apparatus according to the first embodiment of the present invention.

FIG. 6 is a flowchart for explaining the B-level control routine to be executed by the camera apparatus according to the first embodiment of the present invention.

FIG. 7 is a flowchart for explaining the second main routine to be executed by the camera apparatus according to the second embodiment of the present invention.

FIG. 8 is a flowchart for explaining the third main routine to be executed by the camera apparatus according to the third embodiment of the present invention.

FIG. 9 is a flowchart for explaining the fourth main routine to be executed by the camera apparatus according to the fourth embodiment of the present invention.

FIG. 10 is a flowchart for explaining the fifth main routine to be executed by the camera apparatus according to the fifth embodiment of the present invention.

FIG. 11 is a flowchart for explaining the sixth main routine to be executed by the camera apparatus according to the sixth embodiment of the present invention.

### EXPLANATION OF THE REFERENCE NUMERALS

1: camera apparatus
11: image providing means
12: converting means
13: gain adjusting means
14: white balance controlling means
15: image signal outputting means
111: lens unit
112: aperture diaphragm
113: CC filter
114: ND filter
121: dichroic prism
122: R-CCD
123: B-CCD
124: B-CCD
131: R-preamplifier
132: G-preamplifier
133: B-preamplifier
134: R-gain controller
135: G-gain controller
136: B-gain controller
141: R-multiplier
142: B-multiplier
143: aperture controller
144: filter controller
2: microprocessor
21: CPU
22: memory unit
23: buffer unit
24: D/A converter
25: interface unit
25: bus line
3: A/D converter

### DESCRIPTION OF THE PREFERRED EMBODIMENTS

The camera apparatus according to the first to sixth embodiments of the present invention will be described hereinafter with reference to accompanying drawings.

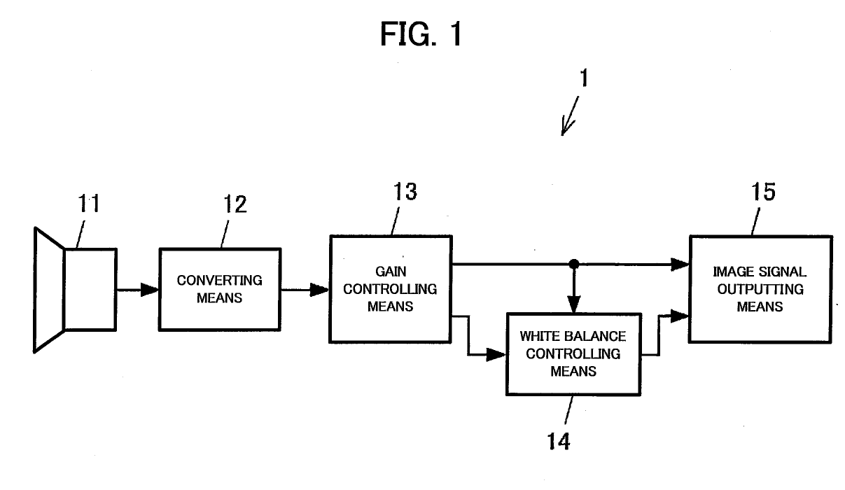

As shown in FIG. 1, the camera apparatus 1 according to the present invention comprises image providing means 11 for providing R-, G-, and B-images corresponding to primary colors in light “R”, “G”, and “B”, converting means 12 for converting the R-, G-, and B-images into R-, G-, and B-image signals, gain adjusting means 13 for adjusting gains corresponding to the R-, G-, and B-image signals, and regulating the R-, G-, and B-image signals on the basis of the adjusted gains, white balance controlling means 14 for controlling, in white balance, the R-, G-, and B-image signals regulated by the gain adjusting means 13, image signal outputting means 15 for outputting the R-, G-, and B-image signals controlled in white balance by the white balance controlling means 14.

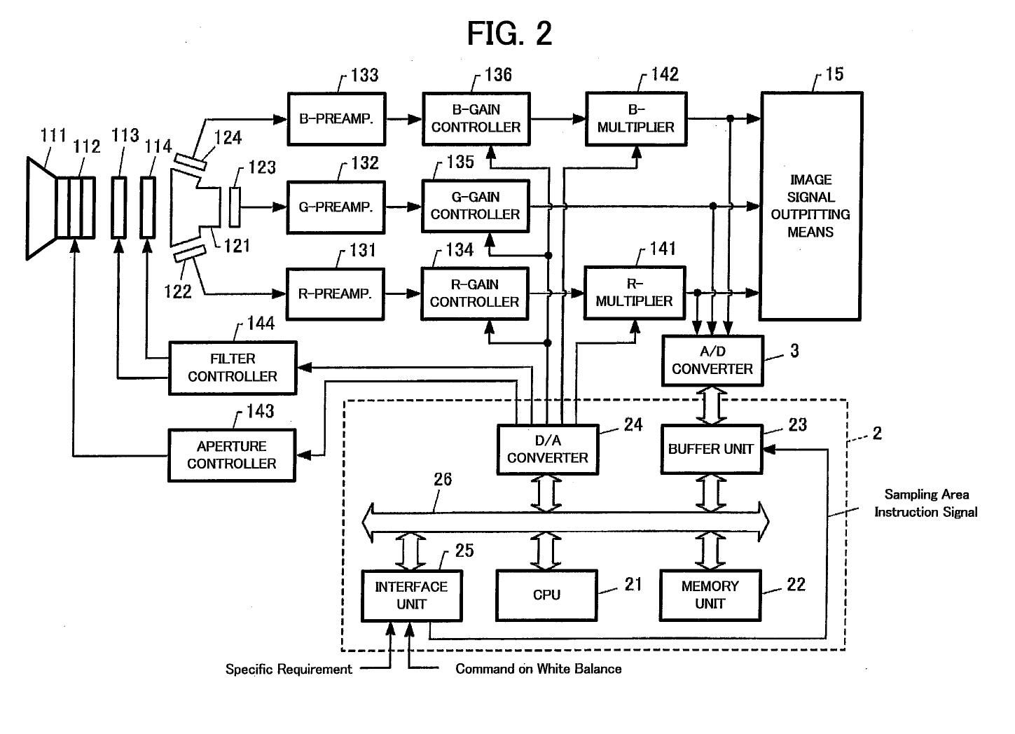

FIG. 2 is a detailed block diagram showing the camera apparatus according to the present invention. As shown in FIG. 2, the image providing means 11 includes a lens unit 111 having a light (coming from an object) passed therethrough, an aperture diaphragm 112 for adjusting, in a continuous fashion, the amount of light (to be received by the converting means 12 through the lens unit 111), a chromatic compensation filter (CC filter) 113 for performing, on the basis of color temperature of lamp or the like, a chromatic compensation of the R-, G-, and B-images to be provided by the image providing means 11, and one or more neutral density filters (ND filter) 114 for adjusting, in a stepwise fashion, the amount of light (to be received by the converting means 12 through the lens unit 111).

The converting means 12 includes a dichroic prism 121 for splitting the light into R-, G-, and B-components, and CCDs 122 to 124 for converting the R-, G-, and B-images (corresponding to the R-, G-, and B-components) into R-, G-, and B-image signals.

The gain adjusting means 13 includes R-, G-, and B-preamplifiers 131 to 133 for amplifying the R-, G-, and B-image signals outputted by the CCDs 122 to 124, and R-, G-, and B-gain controllers 134 to 136 for adjusting the gains on the basis of the amplified R-, G-, and B-image signals.

The white balance controlling means 14 includes a microprocessor 2 for outputting R- and B-level control signals on the basis of the R-, G-, and B-image signals regulated on the basis of the adjusted gains, an analog-to-digital converter (hereinafter referred to as “A/D converter”) 3 for converting the R-, G-, and B-image signals into digital signals, and R- and G-multipliers 141 and 142 for respectively multiplying the R- and B-image signals (regulated on the basis of the adjusted gains) by the R- and G-control signals. In other words, the microprocessor 2, the A/D converter 3, and, the R-multiplier 141 collectively functions as a signal controller for controlling the R-image signal. The microprocessor 2, the A/D converter 3, and, the B-multiplier 142 collectively functions as a signal controller for controlling the B-image signal.

Additionally, the camera apparatus 1 may further comprise, as a real device, an aperture controller 143 for controlling the aperture diaphragm 112 on the basis of a control signal produced by the microprocessor 2, and a controller 144 for controlling the CC filter 113 and the ND filter 114 on the basis of a control signal produced by the microprocessor 2.

The microprocessor 2 has a memory unit 22 having a program stored therein, a central processing unit (CPU) 21 for executing the program, a buffer unit 23 for buffering the digital signals (converted from the R-, G-, and B-image signals by the A/D converter 3), and an digital-to-analog converter (hereinafter referred to as “D/A converter”) 24 for converting the R- and G-level control signals into respective analog signals, an interface unit 25 for receiving information on specific condition or an instruction (on white balance) from an external apparatus. The CPU 21, the memory unit 22, the buffer unit 23, the D/A converter 24, and the interface unit 25 are electrically connected to one another through a bus line 26.

The following description will be directed to the operations of the camera apparatus according to the first to sixth embodiments of the present invention. Each operation of the camera apparatus according to the first to sixth embodiments of the present invention is characterized by the program installed into the memory unit 22.

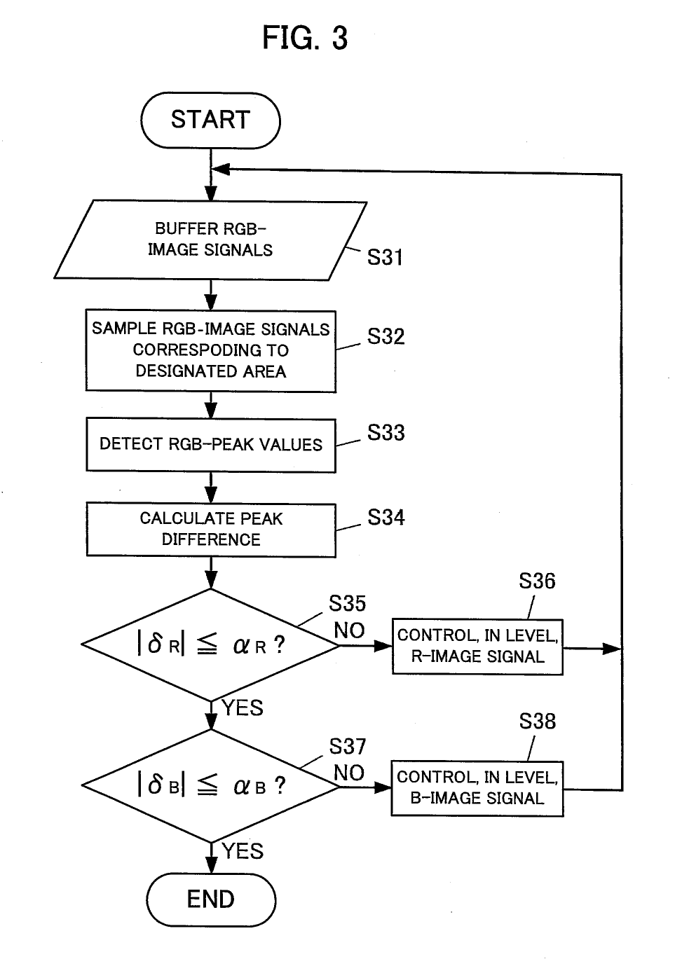

The operation of the camera apparatus according to the first embodiment of the present invention will be firstly described hereinafter with reference to the first main routine shown by the flowchart of FIG. 3.

The regulated R-image signal (from the R-multiplier 141), the regulated G-image signal (from the G-gain controller 135), and the regulated B-image signal (from the R-multiplier 142) are received by the CPU 21 through the A/D converter 3, and then buffered in the buffer unit 23 (in the step S31).

Then, the CPU 21 executes a sampling routine to ensure that the R-, G-, and B-image signals sampled in a designated area of the R-, G-, and B-images are obtained from the regulated R-, G-, and B-image signals (in the step S32). More specifically, the CPU 21 outputs, a control signal for designating an area useful in controlling the white balance of the R-, G-, and B-image signals of each field, to the buffer unit 23 through the interface unit 25 to ensure that the buffer unit 23 outputs the R-, G-, and B-image signals sampled in the designated area in response to the control signal. Here, this area may account for, for example, 25[%], 50[%], or 90[%] of the R-, G-, and B-images.

Then, the CPU 21 detects peak values “P_{R}”, “P_{G}”, and “P_{B}” from the sampled R-, G-, and B-image signals (in the step S33).

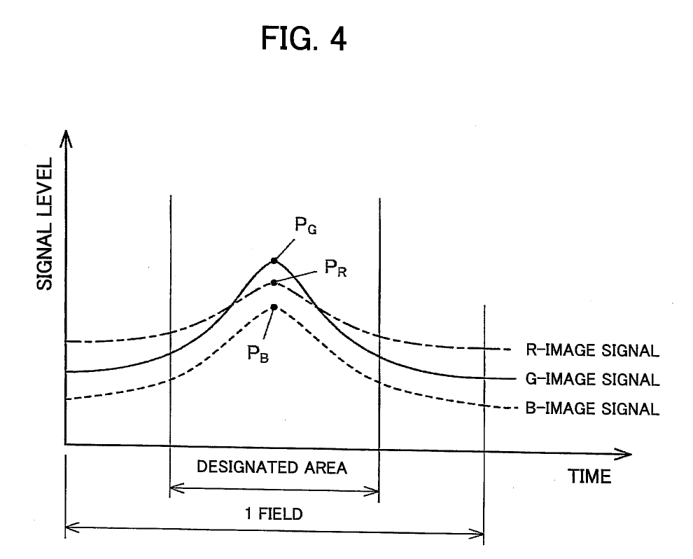

FIG. 4 is a waveform chart schematically showing the R-, G-, and B-image signals of each field under the condition that the designated area is in the center of each image, and accounts for 50% of each image. As shown in FIG. 4, the peaks of the R-, G-, and B-image signals sampled in the designated area are detected as the peak values “P_{R}”, “P_{G}”, and “P_{B}”.

The difference “δ_{R}” between the peak value “P_{R}” of the R-image signal and the peak value “P_{G}” of the G-image signal and the difference “δ_{B}” between the peak value “P_{B}” of the B-image signal and the peak value “P_{G}” of the G-image signal are then calculated by the CPU 21 (in the step S34).

The judgment is made (in the step S35) by the CPU 21 on whether or not the absolute value of the difference “δ_{R}” between the peak value “P_{R}” of the R-image signal and the peak value “P_{G}” of the G-image signal exceeds a predetermined threshold level “α_{R}”. When the absolute value of the difference “δ_{R}” between the peak value “P_{R}” of the R-image signal and the peak value “P_{G}” of the G-image signal exceeds the threshold level “α_{R}”, the CPU 21 adjusts, in amplitude, the R-image signal (in the step S36), and proceeds to the step S31.

When, on the other hand, the absolute value of the difference “δ_{R}” between the peak value “P_{R}” of the R-image signal and the peak value “P_{G}” of the G-image signal does not exceed the threshold level “α_{R}”, the judgment is made (in the step S37) by the CPU 21 on whether or not the absolute value of the difference “δ_{B}” between the peak value “P_{B}” of the B-image signal and the peak value “P_{G}” of the G-image signal exceeds a predetermined threshold level “α_{B}”. When the absolute value of the difference “δ_{B}” between the peak value “P_{B}” of the B-image signal and the peak value “P_{G}” of the G-image signal exceeds the threshold level “α_{B}”, the CPU 21 adjusts, in amplitude, the B-image signal (in the step S38), and proceeds to the step S31. When, on the other hand, the absolute value of the difference “δ_{B}” between the peak value “P_{B}” of the B-image signal and the peak value “P_{G}” of the G-image signal exceeds the threshold level “α_{B}”, the CPU completes this routine.

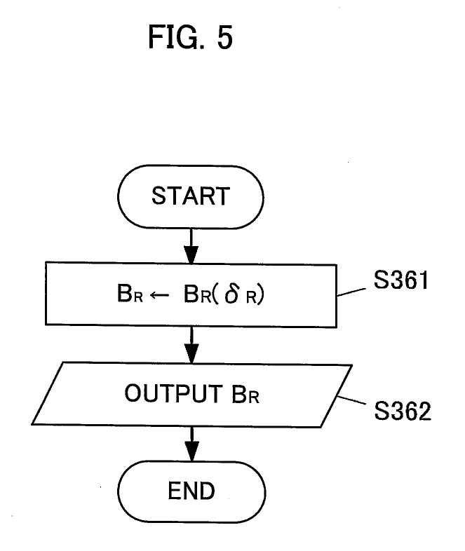

The operation of the camera apparatus according to the first embodiment of the present invention will be described hereinafter with reference to a flowchart showing a R-level control routine to be executed in the step S36 of the first main routine shown by the flowchart of FIG. 5.

The CPU 21 calculates the R-level control signal “B_{R}” as a function of the difference “δ_{R}” between the peak value “P_{R}” of the R-image signal and the peak value “P_{G}” of the G-image signal (in the step S361), outputs the R-level control signal “B_{R}” to the R-multiplier 141 (in the step S362), and completes the R-level control routine.

The R-multiplier 141 multiplies the regulated R-image signal by the R-level control signal “B_{R}”, and outputs the R-image signal multiplied by the R-level control signal “B_{R}” as a R-image signal controlled in level to the image signal outputting means 15.

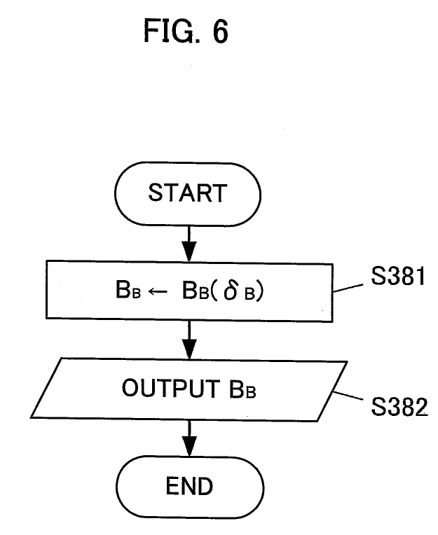

The operation of the camera apparatus according to the first embodiment of the present invention will be described hereinafter with reference to a flowchart showing a B-level control routine to be executed in the step S38 of the first main routine shown by the flowchart of the FIG. 6.

The CPU 21 calculates the B-level control signal “B_{B}” as a function of the difference “δ_{B}” between the peak value “P_{B}” of the B-image signal and the peak value “P_{G}” of the G-image signal (in the step S381), outputs the B-level control signal “B_{B}” to the B-multiplier 142 (in the step S382), and completes the B-level control routine.

The B-multiplier 142 multiplies the regulated B-image signal by the B-level control signal “B_{B}”, and outputs the B-image signal multiplied by the B-level control signal “B_{B}” to the image signal outputting means 15 as a B-image signal controlled in level.

In order to enhance images to be taken over a long period of time, it is preferable to avoid rapid changes of R- and B-level control signals “B_{R}” and “B_{B}” by receiving the regulated R-, G-, and B-image signals from the D/A converter 24 through low-pass filter or the like.

From the foregoing description, it will be understood that the camera apparatus according to the first embodiment of the present invention can control, in white balance, the R-, G-, and B-image signals with accuracy by using the R-, G-, and B-image signals sampled in a designated area of the R-, G-, and B-images.

The following description will be directed to the operation of the camera apparatus according to the second embodiment of the present invention.

When the R-, G-, and B-image signals are controlled in white balance in response to the peak values detected in each field, the R-, G-, and B-image signals tends to become unstable in white balance. In order to prevent the R-, G-, and B-image signals from become unstable in white balance, the camera apparatus according to the present invention may adapted to control, in white balance, the R-, G-, and B-image signals at a relatively low control speed, and to allow an operator to manually correct, in white balance, the R-, G-, and B-image signals at a relatively high control speed. In other words, the camera apparatus according to the present invention may be adapted to automatically change the control speed, or to allow the operator to manually change the control speed.

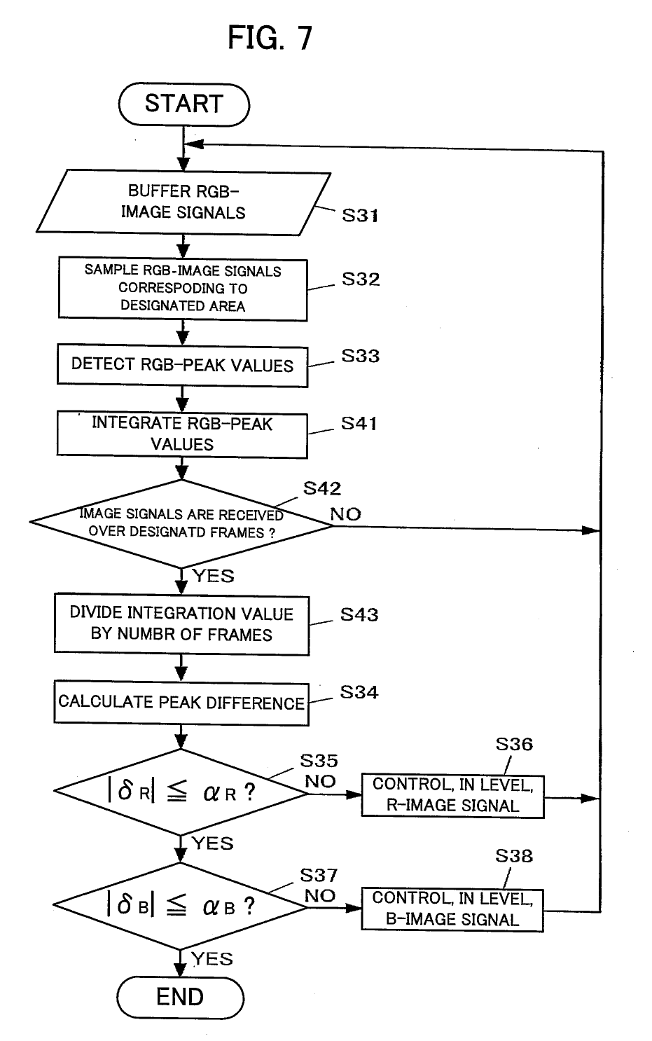

FIG. 7 is a flowchart showing the second main routine to be executed by the CPU 21 of the camera apparatus according to the second embodiment of the present invention. As shown in FIG. 7, the second main routine is substantially the same as the first main routine with the exception that the second main routine includes a routine to be executed in the steps S41 to S43 defined between the steps S33 and S34 in order to control the white balance at a designated control speed.

The CPU 21 detects, in each field, peak values of the sampled R-, G-, and B-image signals (in the step S33) while integrating the detected peak values (in the step S41).

The judgment is then made by the CPU 21 (in the step S42) on whether or not the peak values are detected and integrated over a designated period of time (for example 16 frames). When the peak values are not detected and integrated over the designated fields, the CPU 21 returns to the step S31 to continue to receive the sampled R-, G-, and B-image signals of next field.

When, on the other hand, the peak values are detected and integrated over the designated fields, the CPU 21 calculates averaged peak values by dividing the integrated peak values by the number of the designated fields (in the step S43).

Accordingly, the camera apparatus according to the second embodiment can decrease a control speed at which the R-, G-, and B-image signals are controlled in white balance, by increasing the number of fields over which the peak values and integrated, and increase the control speed by decreasing the number of fields over which the peak values and integrated.

The routines of the camera apparatus according to the second embodiment are substantially the same as those of the camera apparatus according to the first embodiment with the exception of the above-mentioned routines. Therefore, the routines of the camera apparatus according to the second embodiment substantially the same as those of the camera apparatus according to the first embodiment will not be described hereinafter.

From the foregoing description, it will be understood that the camera apparatus according to the second embodiment of the present invention can change, a control speed at which the R-, G-, and B-image signals are controlled in white balance, by detecting, in each field, peak values of the sampled R-, G-, and B-image signals while integrating the detected peak values.

The following description will be directed to the operation of the camera apparatus according to the third embodiment of the present invention.

In order to enhance images to be taken over a long period of time, the camera apparatus according to the present invention may be adapted to correct, in white balance, the R-, G-, and B-image signals when an image to be represented by the regulated R-, G-, and B-image signals is identified as a monochromatic image.

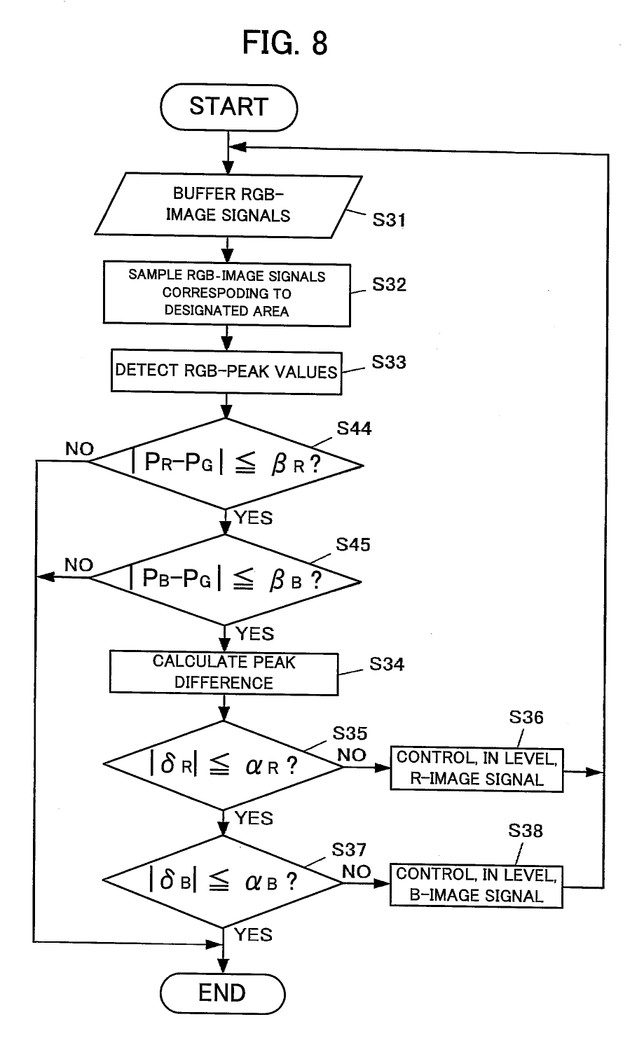

FIG. 8 is a flowchart showing the third main routine to be executed by the CPU 21 of the camera apparatus according to the third embodiment of the present invention. As shown in FIG. 8, the third main routine is substantially the same as the first main routine with the exception that the third main routine includes a routine to be executed in the steps S44 and S45 defined between the steps S33 and S34 in order to decide whether or not to identify, as a monochromatic image, an image to be represented by the regulated R-, G-, and B-image signals.

The CPU 21 detects, in each field, peak values of the sampled R-, G-, and B-image signals (in the step S33) while judging (in the step S44) whether or not the absolute value of the difference “δ_{R}” between the peak value “P_{R}” of the R-image signal and the peak value “P_{G}” of the G-image signal exceeds a predetermined threshold level “δ_{R}”.

When the absolute value of the difference “δ_{R}” between the peak value “P_{R}” of the R-image signal and the peak value “P_{G}” of the G-image signal exceeds the threshold level “δ_{R}”, the CPU 21 identifies, as a color image, an image to be represented by the regulated R-, G-, and B-image signals, and completes this routine without adjusting, in white balance, the regulated R-, G-, and B-image signals.

When, on the other hand, the absolute value of the difference “δ_{R}” between the peak value “P_{R}” of the R-image signal and the peak value “P_{G}” of the G-image signal does not exceed the threshold level “β_{R}”, the judgment is made by the CPU 21 (in the step S45) on whether or not the absolute value of the difference “δ_{B}” between the peak value “P_{B}” of the B-image signal and the peak value “P_{G}” of the G-image signal exceeds a predetermined threshold level “β_{B}”.

When the absolute value of the difference “δ_{B}” between the peak value “P_{B}” of the B-image signal and the peak value “P_{G}” of the G-image signal exceeds the threshold level “β_{B}”, the CPU 21 identifies, as a color image, an image to be represented by the regulated R-, G-, and B-image signals, and completes this routine without adjusting, in white balance, the regulated R-, G-, and B-image signals.

When, on the other hand, the absolute value of the difference “δ_{R}” between the peak value “P_{R}” of the R-image signal and the peak value “P_{G}” of the G-image signal does not exceed the threshold level “β_{R}”, and the absolute value of the difference “δ_{B}” between the peak value “P_{B}” of the B-image signal and the peak value “P_{G}” of the G-image signal does not exceed the threshold level “β_{B}”, the CPU 21 identifies, as a monochromatic image, an image to be represented by the regulated R-, G-, and B-image signals.

The routines of the camera apparatus according to the third embodiment are substantially the same as those of the camera apparatus according to the first embodiment with the exception of the above-mentioned routines. Therefore, the routines of the camera apparatus according to the third embodiment substantially the same as those of the camera apparatus according to the first embodiment will not be described hereinafter.

From the foregoing description, it will be understood that the camera apparatus according to the second embodiment of the present invention can prevent an image identified as a monochromatic image from being outputted to the image signal outputting means by adjusting, in white balance, the R-, G-, and B-image signals when the image is identified as a monochromatic image.

The following description will be directed to the operation of the camera apparatus according to the fourth embodiment of the present invention.

It is preferable to prevent the R-, G-, and B-image signals from being changed in white balance at a relatively high control speed under specific conditions, and to stop controlling, in white balance, the R-, G-, and B-image signals under specific conditions.

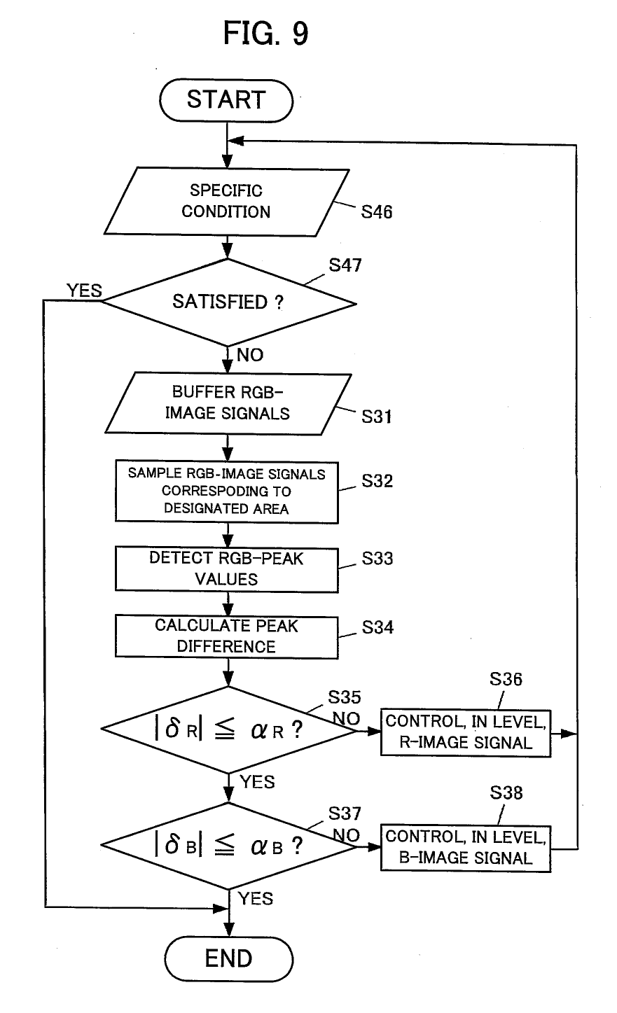

FIG. 9 is a flowchart showing the fourth main routine to be executed by the CPU 21 of the camera apparatus according to the fourth embodiment of the present invention. As shown in FIG. 9, the fourth main routine is substantially the same as the first main routine with the exception that the fourth main routine includes a routine to be executed in the steps S46 and S47 defined before the step S31 in order to force the CPU 21 to stop controlling, in white balance, the R-, G-, and B-image signals under specific conditions.

The CPU 21 receives control information through the interface unit 25 (in the step S46), and judges as being under specific conditions (in the step S47).

When the specific conditions are true, the CPU 21 completes the fourth main routine without controlling, in white balance, the R-, G-, and B-image signals. When, on the other hand, the specific conditions are false, the CPU 21 continues to execute the fourth main routine to control, in white balance, the R-, G-, and B-image signals.

The routines of the camera apparatus according to the fourth embodiment are substantially the same as those of the camera apparatus according to the first embodiment with the exception of the above-mentioned routines. Therefore, the routines of the camera apparatus according to the fourth embodiment substantially the same as those of the camera apparatus according to the first embodiment will not be described hereinafter.

From the foregoing description, it will be understood that the camera apparatus according to the fourth embodiment of the present invention can stop controlling, in white balance, the R-, G-, and B-image signals under specific conditions.

The following description will be directed to the operation of the camera apparatus according to the fifth embodiment of the present invention.

When the gains “G” to be adjusted by the R-, G-, and B-gain controllers 134, 135, and 136 are remaining at a relatively high level, the R-, G-, and B-image signals have noises higher than usual. Accordingly, it is preferable to stop correcting, in white balance, the R-, G-, and B-image signals when the gains “G” to be adjusted by the R-, G-, and B-gain controllers 134, 135, and 136 are remaining at a relatively high level.

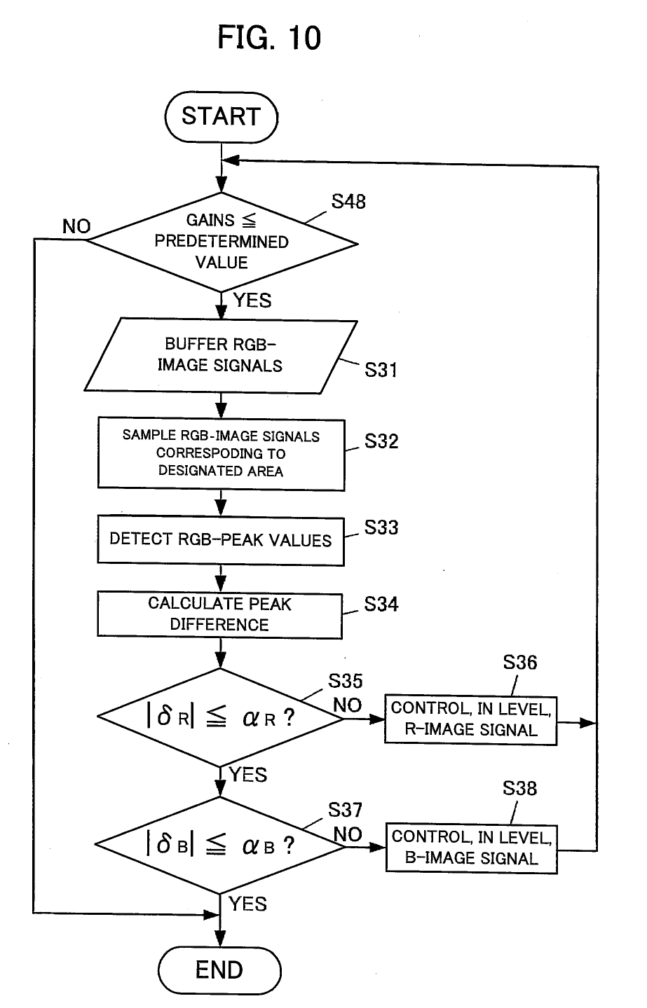

FIG. 10 is a flowchart showing the fifth main routine to be executed by the CPU 21 of the camera apparatus according to the fifth embodiment of the present invention. As shown in FIG. 10, the fifth main routine is substantially the same as the first main routine with the exception that the fifth main routine includes a routine to be executed in the step S48 defined before the step S31 in order to prevent the CPU 21 from controlling, in white balance, the R-, G-, and B-image signals when the gains to be respectively adjusted by the R-, G-, and B-gain controllers 134, 135, and 136 exceeds a predetermined threshold level.

The judgment is made by the CPU 21 (in the step S48) whether or not one or more of the gains “G” to be respectively adjusted by the R-, G-, and B-gain controllers 134, 135, and 136 exceed a predetermined threshold level “G_{H}” (for example, 24 [dB]).

When one or more of the gains “G” to be respectively adjusted by the R-, G-, and B-gain controllers 134, 135, and 136 exceed the threshold level “G_{H}”, the CPU 21 completes this routine without controlling, in white balance, the R-, G-, and B-image signals. When, on the other hand, one or more of the gains “G” to be respectively adjusted by the R-, G-, and B-gain controllers 134, 135, and 136 don't exceed the threshold level “G_{H}”, the CPU 21 proceeds to the step S31 to control, in white balance, the R-, G-, and B-image signals.

The routines of the camera apparatus according to the fifth embodiment are substantially the same as those of the camera apparatus according to the first embodiment with the exception of the above-mentioned routines. Therefore, the routines of the camera apparatus according to the fifth embodiment substantially the same as those of the camera apparatus according to the first embodiment will not be described hereinafter.

From the foregoing description, it will be understood that the camera apparatus according to the fifth embodiment of the present invention can prevent the CPU 21 from controlling, in white balance, the R-, G-, and B-image signals by stopping controlling, in white balance, the R-, G-, and B-image signals when the gains “G” to be respectively adjusted by the R-, G-, and B-gain controllers 134, 135, and 136 exceed the threshold level “G_{H}”.

The following description will be directed to the operation of the camera apparatus according to the sixth embodiment of the present invention.

In order to prevent from falling into a negative spiral of hunting, it is preferable to restart controlling, in white balance, the R-, G-, and B-image signals over a designated period of time.

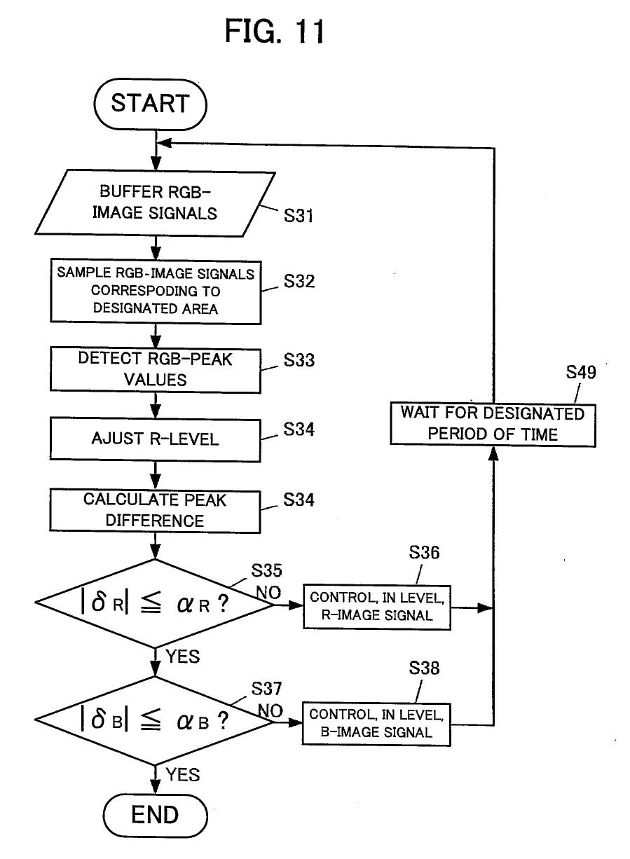

FIG. 11 is a flowchart showing the fifth main routine to be executed by the CPU 21 of the camera apparatus according to the sixth embodiment of the present invention. As shown in FIG. 11, the sixth main routine is substantially the same as the first main routine with the exception that the sixth main routine includes a routine to be executed in the step S49 defined after the steps S36 and S38 in order to prevent the CPU 21 from controlling, in white balance, the R-, G-, and B-image signals over a predetermined period of time before allowing the CPU 21 to return to the step 31.

The CPU 21 waits for a designated period of time (which may correspond to, for example, a few fields) in the step S49, without controlling, in white balance, the R-, G-, and B-image signals, after controlling, in white balance, the R-, G-, and B-image signals by adjusting, in amplitude, the R-image signal (in the step S36), or by adjusting, in amplitude, the B-image signal (in the step S38).

From the foregoing description, it will be understood that the camera apparatus according to the sixth embodiment of the present invention can prevent the CPU 21 from falling into a negative spiral of hunting by preventing the CPU 21 from restarting controlling, in white balance, the R-, G-, and B-image signals over a designated period of time.

While there has been described in the foregoing embodiments about the fact that the camera apparatus according to the present invention is adapted to automatically control, in white balance, the R-, G-, and B-image signals. The camera apparatus according to the present invention may be adapted to allow an operator to manually correct, in white balance, the R-, G-, and B-image signals.

In the camera apparatus according to the present invention, the CPU 21 may be adapted to execute the first main routine shown by the flowchart of FIG. 3 in response to a command on white balance received through the interface unit 24, and to correct, in white balance, the R-, G-, and B-image signals in response to a forcible command on white balance. Needless to say, the peak values of the R-, G-, and B-image signals calculated in a brief period of time, i.e., few fields.

In the first to sixth embodiments, each of the R-, G-, and B-gain controllers 134, 135, and 136, each of the R- and B-multipliers 141 and 142, and the image signal outputting means 15 is constituted by an analog circuit. However, each of the R-, G-, and B-gain controllers 154, 155, and 156, each of the R- and B-multipliers 141 and 142, and the image signal outputting means 17 may be constituted by a digital circuit.

Each of the second to sixth embodiments of the camera apparatus has been described as an embodiment modified from the first embodiment of the camera apparatus. It will be obvious to those skilled in the art that various changes may be made without departing from the scope of the invention.

### INDUSTRIAL APPLICABILITY OF THE PRESENT INVENTION

As will be seen from the foregoing description, the camera apparatus according to the present invention has an advantageous effect of taking images over a long period of time while automatically controlling, in white balance, the images, and useful as a camera apparatus for automatically controlling, in white balance, images.

What is claimed is:

1. A camera apparatus, comprising:
image providing means for providing R-, G-, and B-images corresponding to three primary colors in light;
converting means for converting said R-, G-, and B-images into R-, G-, and B-image signals;
gain adjusting means for adjusting gains corresponding to said R-, G-, and B-image signals, and regulating said R-, G-, and B-image signals on the basis of said adjusted gains;
white balance controlling means for controlling, in white balance, said regulated R-, G-, and B-image signals; and
image signal outputting means for outputting said R-, G-, and B-image signals controlled in white balance, wherein
said white balance controlling means includes:
image signal sampler for extracting, from said regulated R-, G-, and B-image signals, R-, G-, and B-image signals corresponding to a specific sampling area, said extracted R-, G-, and B-image signals having R-, G-, and B-peak values;
peak value detector for detecting said R-, G-, and B-peak values from said extracted R-, G-, and B-image signals;
R-level controller for controlling, in level, said regulated R-image signal on the basis of a difference between said G- and R-peak values; and
B-level controller for controlling, in level, said regulated B-image signal on the basis of a difference between said G- and B-peak values.

2. A camera apparatus as set forth in claim 1, in which said white balance controlling means is adapted to utilize, as said R-, G-, and B-peak values, mean values of said R-, G-, and B-peak values calculated over a first period of time.

3. A camera apparatus as set forth in claim 1, in which said white balance controlling means is adapted to stop controlling said white balance when the judgment is made that an absolute value of either said difference between said G- and R-peak values or said difference between said G- and B-peak values exceeds a specific threshold level.

4. A camera apparatus as set forth in claim 1, in which said white balance controlling means is adapted to stop correcting said white balance when the judgment is made that said while balance meets a specific requirement.

5. A camera apparatus as set forth in claim 1, in which said white balance controlling means is adapted to stop correcting said white balance when the judgment is made that said gains adjusted by said gain adjusting means are respectively larger than or equal to threshold levels.

6. A camera apparatus as set forth in claim 1, in which said white balance controlling means is adapted to stop, over a second period of time, correcting said white balance after allowing said R-, and G-level controller to perform a level control of said R-image signal, or allowing said B-level controller to perform a level control of said B-image signal.
